(19) United States
(12) Patent Application Publication
(10) Pub. No.: US 2013/0321263 A1
(43) Pub. Date: Dec. 5, 2013

(54) SYSTEM AND METHOD FOR UNLOCKING SCREEN OF PORTABLE ELECTRONIC DEVICE

(71) Applicant: HON HAI PRECISION INDUSTRY CO., LTD., New Taipei (TW)

(72) Inventor: TEN-CHEN HO, New Taipei (TW)

(73) Assignee: HON HAI PRECISION INDUSTRY CO., LTD., New Taipei (TW)

(21) Appl. No.: 13/863,339

(22) Filed: Apr. 15, 2013

(30) Foreign Application Priority Data
May 31, 2012 (CN) 201210175136.7

(51) Int. Cl. G06F 3/03

(52) U.S. Cl. CPC G06F 3/03
USPC 345/156

(57) ABSTRACT

A method executes a gyroscope and an accelerometer function to unlock a portable electronic device. A user can rotate the portable electronic device to set a predetermined rotation direction, a predetermined rotation angle, and a predetermined accelerometer for unlocking the portable electronic device. In an unlock procedure, the gyroscope and the accelerometer detect the rotated portable electronic device and outputs detected information of the portable electronic device. If the rotation direction, the rotation angle, and the acceleration are the same as the predetermined rotation direction, the predetermined rotation angle, and the predetermined acceleration, respectively, the locked portable electronic device is unlocked.

### BACKGROUND

1. Technical Field

Embodiments of the present disclosure relate to unlocking systems and methods, and particularly to a system and a method for unlocking a screen of a portable electronic device.

2. Description of Related Art

A plurality of portable electronic devices (mobile phone, tablet personal computer, for example) use touch screens. A touch screen is easy to be inadvertently activated, thus a screen lock is often adopted to avoid unintentional operations. Usually, a user has to perform a slide operation on the touch screen to unlock a screen of the touch screen. However, too many slides may damage the touch screen.

### BRIEF DESCRIPTION OF THE DRAWINGS

Many aspects of the present disclosure can be better understood with reference to the following drawing. The components in the drawing are not necessarily drawn to scale, the emphasis instead being placed upon clearly illustrating the principles of the disclosure.

FIG. 1 is a block diagram of one embodiment of a portable electronic device having an unlocking system.

FIG. 2 is a block diagram of one embodiment of function modules of the unlocking system in FIG. 1.

FIG. 3 is a flowchart illustrating one embodiment of a method for unlocking a screen of a portable electronic device.

FIGS. 4A, 4B, and 4C are schematic views of a rotation process of the portable electronic device of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

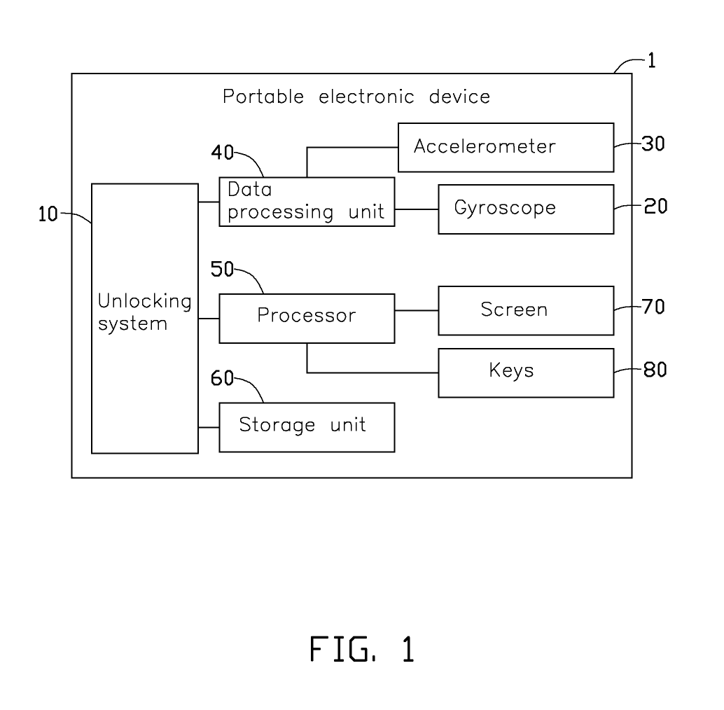

FIG. 1 is a block diagram of one embodiment of a portable electronic device 1. The portable electronic device 1 includes an unlocking system 10. The portable electronic device 1 includes an unlocking system 10, a gyroscope 20, an accelerometer 30, a data processing unit 40, a screen 70, and a plurality of keys 80. In some embodiments, the portable electronic device 1 may be a mobile phone or a tablet personal computer, for example.

The gyroscope 20 detects an angular rotation of the portable electronic device 1. The accelerometer 30 detects an acceleration of the portable electronic device 1. The data processing unit 40 converts the angular rotation into a rotation direction and a rotation angle and generates a movement curve of the portable electronic device 1 according to the rotation direction, the rotation, and the acceleration. The movement curve defines as a curve shown on the screen 70 representing movement of the portable electronic device 1. The unlocking system 10 can receive the detected rotation direction, the detected rotation angle, the detected acceleration, and the movement curve from the data processing unit 40, and output the received information to the processor 50. The processor 50 processes the detected rotation direction, the detected rotation angle, the detected acceleration, and the movement curve to be displayed on the screen 70 to inform a user. According to displayed information on the screen 70, the user can unlock the screen 70 of the portable electronic device 1 by adjusting the rotation direction, the rotation angle, and the acceleration of the portable electronic device 1 to match an unlocking condition. The storage unit 60 stores a predetermined rotation direction, a predetermined rotation angle, and a predetermined acceleration of the portable electronic device 1 to unlock the portable electronic device 1 and also store the detected rotation direction, the detected rotation angle from the data processing unit 40, and acceleration of the portable electronic device 1 detected from the gyroscope 20 and the accelerometer 30.

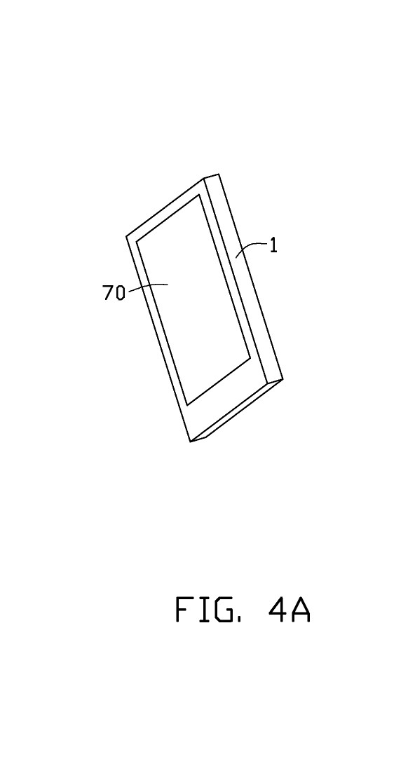

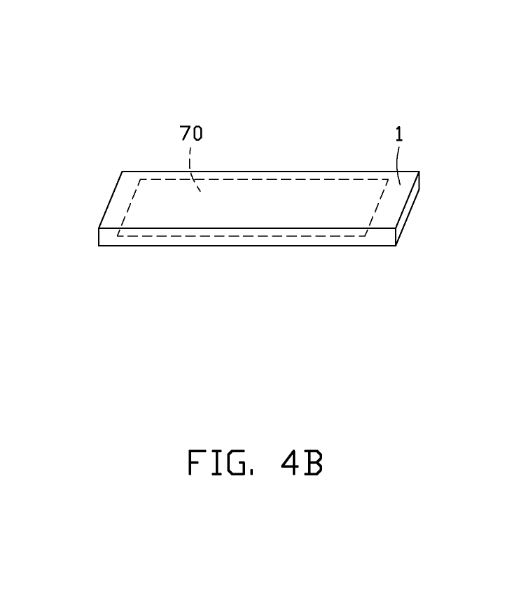

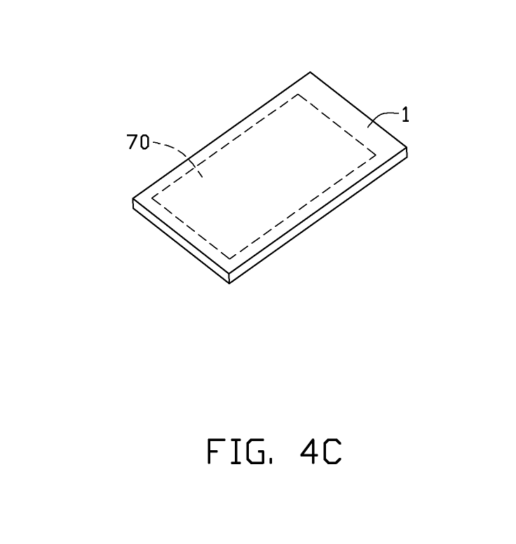

The unlocking condition defines when the portable electronic device 1 is in a locking state, and when the detected rotation direction, the detected rotation angle, and the detected acceleration of the portable electronic device 1 correspondingly match the predetermined rotation direction, the predetermined rotation angle, and the predetermined acceleration stored in the storage unit 60. For example, referring to FIGS. 4A, 4B, and 4C, the predetermined rotation direction and the predetermined rotation angle are set as rotating to about forty-five degrees in the counterclockwise direction by pivoting an end of portable electronic device 1, and then rotating to about forty-five degrees in the counterclockwise direction on a surface of the screen 70 by pivoting the same end of portable electronic device 1. During an unlocking period, the screen 70 displays a current rotation angle of the portable electronic device 1 (such as forty-five degrees, sixty degrees, ninety degrees) until the screen 70 displays that the portable electronic device 1 has been rotated to about 90 degrees rotation angle in the counterclockwise direction that is the detected rotation direction, the detected rotation angle, and the detected acceleration of the portable electronic device 1 correspondingly match the predetermined rotation direction, the predetermined rotation angle, and the predetermined acceleration stored in the storage unit 60 and the portable electronic device 1 is unlocked.

The keys 80 are electrically connected to the processor 50 to provide a conventional unlocking operation such as a password input system to unlock the portable electronic device 1.

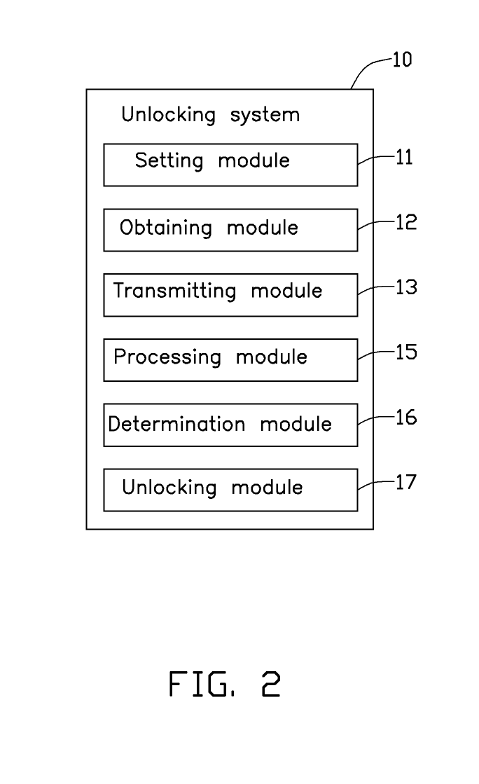

The unlocking system 10 may include one or more modules (shown in FIG. 2). The one or more modules may comprise computerized code in the form of one or more programs that are stored in the storage unit 60. In one embodiment, the storage unit 60 may be a magnetic storage system, an optical storage system, or other suitable storage medium. The computerized code includes instructions that are executed by the processor 50 to provide functions for the one or more modules described below.

As shown in FIG. 2, the unlocking system 10 includes a setting module 11, a obtaining module 12, a transmitting module 13, a processing module 15, a determination module 16, and an unlocking module 17.

The setting module 11 is operable to set the predetermined rotation direction, the predetermined rotation angle, and the predetermined acceleration to unlock the portable electronic device 1. In setting the unlock condition, the gyroscope 20 and the accelerometer 30 continually detects the rotation rate and the acceleration of the portable electronic device 1. The setting module 11 then saves the rotation direction, the rotation angle, and the acceleration detected from the gyroscope 20 and the accelerometer 30 as the predetermined rotation direction, the predetermined rotation angle and the predetermined acceleration in the storage unit 60.

Referring to FIG. 4, in one embodiment, the setting module 11 sets the predetermined rotation direction and the predetermined rotation angle as rotating the portable electronic device 1 to forty-five degrees in a counterclockwise, and continually rotates to 45 degrees in a counterclockwise direction.

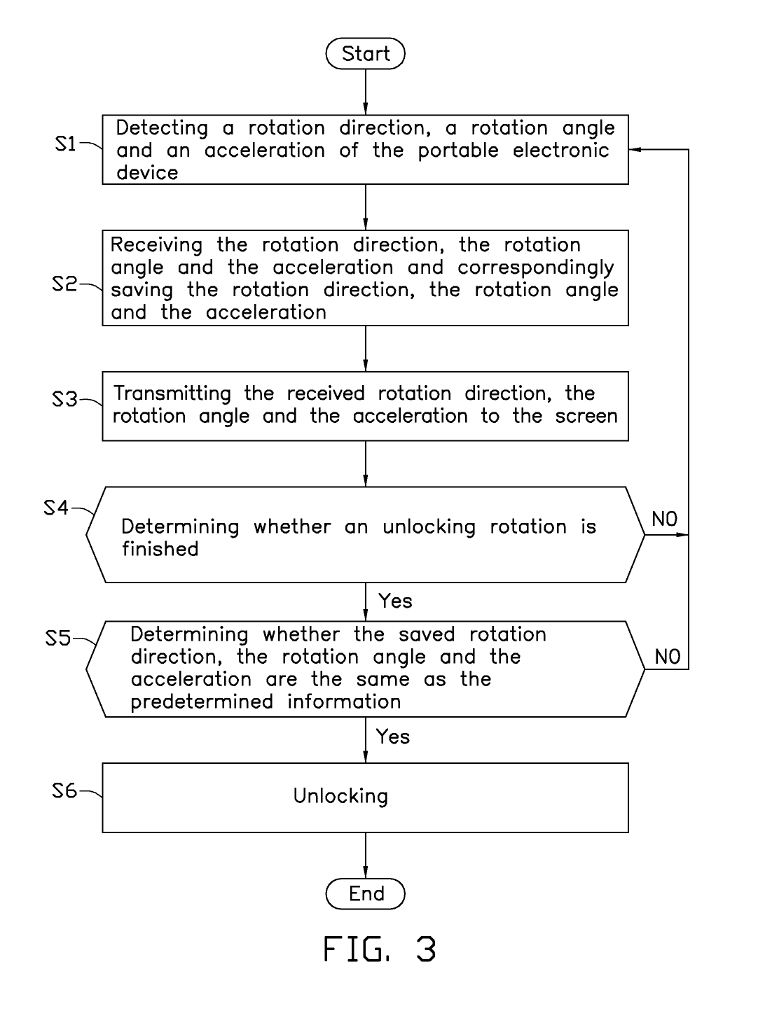

In addition, the setting module 11 also sets a predetermined time period (such as 0.5 seconds or 1 seconds) to determine whether the rotation of the portable electronic device 1 has finished. If the rotation of the portable electronic device 1 has finished in the predetermined time period, the unlocking system 10 executes a next unlock step (i.e. step S5 in FIG. 3); if the rotation of the portable electronic device 1 have not finished in the predetermined time period (such as 1.5 seconds or 2 seconds), a new rotation of the portable electronic device 1 is required (i.e. step 1 in FIG. 3).

The obtaining module 12 receives the rotation direction, the rotation angle and the acceleration of the portable electronic device 1 detected by the gyroscope 20 and the accelerometer 30 during the rotation period from the data processing unit 40. Furthermore, the obtaining module 12 saves the received information in the storage unit 60.

The transmitting module 13 transmits the rotation direction, the rotation angle, and the acceleration of the portable electronic device 1 received from the obtaining module 12 to the processor 50. The processor 50 controls the screen 70 to inform the user.

The processing module 15 determines whether the rotation direction, the rotation angle and the acceleration stored in the storage unit 60 change within the predetermined time period and thereby determining whether the rotation of the portable electronic device 1 has stopped. For example, if the rotation direction, the rotation angle and the acceleration stored in the storage unit 60 do not change within the predetermined time period, the checking module 104 determines the rotation of the portable electronic device 1 has stopped. If the rotation direction, the rotation angle and the acceleration stored in the storage unit 60 change within the predetermined time period, the processing module 15 determines that the portable electronic device 1 is still being rotated for unlocking the screen 70.

The determination module 16 determines whether the rotation direction, the rotation angle, and the acceleration are the same as the predetermined rotation direction, the predetermined rotation angle, and the predetermined acceleration, respectively. In one embodiment, the obtaining module 12 continually saves the rotation direction, the rotation angle, and the acceleration of the portable electronic device 1 detected from the gyroscope 11 and the accelerometer 30 in the storage unit 60 during the rotation period. The determination module 16 reads the predetermined rotation direction, and the predetermined rotation angle, and the predetermined acceleration stored in the storage unit 60. Then, the determination module 16 determines whether the rotation direction, the rotation angle, and the acceleration are same as the predetermined rotation direction and the predetermined rotation angle, and the predetermined acceleration, respectively. If the rotation direction, the rotation angle, and the acceleration are not the same as the predetermined rotation direction and the predetermined rotation angle, and the predetermined acceleration, the determination module 16 determines that the portable electronic device 1 stays locked. Otherwise, If the rotation direction, the rotation angle, and the acceleration are the same as the predetermined rotation direction and the predetermined rotation angle, and the predetermined acceleration, the determination module 16 sends an unlock signal to the unlocking module 17.

The unlocking module 17 receives the unlock signal from the determination module 16 and control the processor 50 to unlock the portable electronic device 1.

FIG. 3 is a flowchart of one embodiment of a method for unlocking a portable electronic device 1. Depending on the embodiment, additional steps may be added, others deleted, and the ordering of the steps may be changed.

In step S1, the gyroscope 20 detects a rotation direction and a rotation angle of the portable electronic device 1, and the accelerometer 30 detects an acceleration of the portable electronic device 1.

In step S2, the obtaining module 12 receives the rotation direction and the rotation angle of the portable electronic device 1 detected by the gyroscope 11 and the acceleration of the portable electronic device 1 detected by the accelerometer 30 from the data processing unit 40 and saves received information in the storage unit 60.

In step S3, the transmitting module 13 displays the rotation direction, the rotation angle, and the acceleration of the portable electronic device 1 from the obtaining module 12 on the screen 70.

In step S4, the processing module 15 determines whether the rotation direction, the rotation angle, and the acceleration stored in the storage unit 60 change within a predetermined time period. If the rotation direction, the rotation angle, and the acceleration stored in the storage unit 60 change within the predetermined time period, the processing module 15 determines the rotation of the portable electronic device 1 is continually rotating and returns to step S1. If the rotation direction, the rotation angle, and the acceleration stored in the storage unit 60 do not change within the predetermined time period, step S5 is implemented.

In step S5, the determination module 16 determines whether the rotation direction, the rotation angle, and the acceleration are the same as the predetermined information of rotation direction, rotation angle and acceleration of the portable electronic device 1 stored in the storage unit 60, respectively. In one embodiment, the determination module 15 reads the predetermined rotation direction, the predetermined rotation angle, and the predetermined acceleration stored in the storage unit 60. Then, the determination module 16 determines whether the rotation direction, the rotation angle, and the acceleration are the same as the predetermined rotation direction, the predetermined rotation angle, and the predetermined acceleration. If the rotation direction, the rotation angle, and the acceleration are not the same as the predetermined rotation direction, the predetermined rotation angle, and the predetermined acceleration, the determination module 105 determines that portable electronic device 1 stays locked and returns to step S1. If the rotation direction, the rotation angle, and the acceleration are the same as the predetermined rotation direction, the predetermined rotation angle, and the predetermined acceleration, step S6 is implemented.

In step S6, the unlocking module 17 sends an unlock signal to the processor 50 and controls the processor 50 to unlock the portable electronic device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A portable electronic device, comprising:
a storage unit;
a screen;
at least one processor;
a gyroscope detecting an angular rotation of the portable electronic device;
an data processing unit converting the angular rotation into a rotation direction and a rotation angle;
an accelerometer detecting an acceleration of the portable electronic device;
one or more programs that are stored in the memory and are executed by the at least one processor, the one or more programs comprising:
a setting module setting a predetermined rotation direction, a predetermined rotation angle, and a predetermined acceleration for unlocking the portable electronic device;
a transmitting module displaying the rotation direction, the rotation angle, and the acceleration of the portable electronic device on the screen;
a processing module determining whether the rotation direction, the rotation angle, and the acceleration stored in the storage unit change within a predetermined time period;
a determination module determining whether the rotation direction, the rotation angle, and the acceleration are the same as the predetermined rotation direction, the predetermined rotation angle, and the predetermined acceleration, respectively if the rotation direction, the rotation angle and the acceleration do not change within the predetermined time period; and
an unlocking module controlling the least one processor to unlock the a screen of the portable electronic device if the rotation direction, the rotation angle, and the acceleration are the same as the predetermined rotation direction, the predetermined rotation angle, and the predetermined acceleration, respectively.

2. The portable electronic device of claim 1, the one or more programs further comprising:
a transmitting module displaying the rotation direction, the rotation angle, and the acceleration received from the obtaining module on the screen.

3. The portable electronic device of claim 1, wherein the setting module further sets the predetermined time period.

4. A computer-implemented method for unlocking a portable electronic device, the portable electronic device comprising a gyroscope, an accelerometer, a storage unit, a screen and at least one processor, the method comprising:
receiving a rotation direction, a rotation angle, and an acceleration of the portable electronic device detected from the gyroscope and the accelerometer;
determining whether the rotation direction, the rotation angle, and the acceleration stored in the storage unit change within a predetermined time period;
determining whether the rotation direction, the rotation angle and the acceleration are the same as a predetermined rotation direction, a predetermined rotation angle, and an acceleration stored in the storage unit, respectively if the rotation direction, the rotation angle and the acceleration do not change within the predetermined time period; and
unlocking the portable electronic device if the rotation direction, the rotation angle, and the acceleration are the same as the predetermined rotation direction, the predetermined rotation angle, and the predetermined acceleration.

5. The method of claim 4, further comprising saving the rotation direction, the rotation angle, and the acceleration in the storage unit.

6. The method of claim 4, further comprising:
displaying the rotation direction, the rotation angle, and the acceleration of the portable electronic device from the obtaining module on the screen.

7. The method of claim 6, wherein the step of unlocking the portable electronic device is by unlocking a screen lock or a key lock.

8. The method of claim 4, further comprising:
setting the predetermined time period for unlocking the portable electronic device and saving the predetermined time period in the storage unit.

9. The method of claim 4, further comprising the following steps to set the predetermined rotation direction, the predetermined rotation angle, and the predetermined acceleration:
rotating the portable electronic device;
detecting the rotation direction, the rotation angle, and the acceleration of the portable electronic device by the gyroscope and the accelerometer; and
receiving the rotation direction, the rotation angle, and the acceleration and saving them as the predetermined rotation direction, the predetermined rotation angle, and the predetermined acceleration in the storage unit.

10. A storage medium having stored thereon instructions that, when executed by a processor, causes the processor to perform a method for unlocking a portable electronic device, the method comprising:
detecting a rotation direction, a rotation angle, and an acceleration of the portable electronic device;
determining whether the rotation direction, the rotation angle, and the acceleration stored in a storage unit change within a predetermined time period;
determining whether the rotation direction, the rotation angle, and the acceleration are the same as a predetermined rotation direction, a predetermined rotation angle, and a predetermined acceleration stored in the storage unit, respectively if the rotation direction, the rotation angle, and the acceleration do not change within the predetermined time period; and
unlocking the portable electronic device if the rotation direction, the rotation angle, and the acceleration are the same as the predetermined rotation direction, the predetermined rotation angle, and the predetermined acceleration.

11. The storage medium of claim 10, wherein the method further comprising saving the rotation direction, the rotation angle, and the acceleration in the storage unit.

12. The storage medium of claim 10, wherein the method further comprising:
displaying the rotation direction, the rotation angle, and the acceleration of the portable electronic device from the obtaining module on a screen.

13. The storage medium of claim 10, wherein the step of unlocking the portable electronic device is by unlocking a screen lock or a key lock.

14. The storage medium of claim 10, wherein the method further comprising:
setting the predetermined time period for unlocking the portable electronic device and saving the predetermined time period in the storage unit.

15. The storage medium of claim 10, wherein the method further comprising the following steps to set the predetermined rotation direction, the predetermined rotation angle, and the predetermined acceleration:
rotating the portable electronic device;
detecting the rotation direction, the rotation angle, and the acceleration of the portable electronic device by a gyroscope and an accelerometer; and
receiving the rotation direction, the rotation angle, and the acceleration and saving them as the predetermined rotation direction, the predetermined rotation angle, and the predetermined acceleration in the storage unit.
